(19) United States
(12) Patent Application Publication
(10) Pub. No.: US 2003/0145206 A1
(43) Pub. Date: Jul. 31, 2003

(54) Document authentication and verification

(76) Inventors: Jack Wolosewicz, (US); Andreas Schmidt, Santa Rosa, CA (US)

Correspondence Address: FISH & RICHARDSON PC, 225 FRANKLIN ST, BOSTON, MA, 02110, US

(21) Appl. No.: 10/057,297

(22) Filed: Jan. 25, 2002

(51) Int. Cl. H04L 9/00

(52) U.S. Cl. 713/176

(57) ABSTRACT

A technique of encoding a document to prevent undetected alteration of the document includes identifying symbols to be changed by applying font changes to the identified symbols and generating font change pointers that track changes applied to the identified symbols. Techniques to decode and detect changes are also described.

### BACKGROUND

This invention relates to techniques for making text/images files and documents secure and verifiable.

Technologies exist to authenticate data files to insure that such files have not been altered. A document is said to be secure in this context by insuring that the integrity of the document remains after it is passed between users. One aspect of secure is that changes, whether major or minor cannot be made without being detected.

Some techniques operate on a file that is in an image format. With these techniques an image type watermark is added to the file. An image type watermark requires use with an image file format, and does not work on a text file format. Examples of image file formats include GIF, PDF and JPEG formats. Also, there are techniques that use paper that is embedded with watermarks, e.g., as used in banknotes or currency and so forth.

### SUMMARY

One problem with existing technologies is to make text files secure and verifiable. In particular it is desirable to authenticate the file even after the file has been rendered to a different medium. For example, it is desirable to verify that the file has not been altered in its electronic, digital format as well as after the electronic version is rendered to hard copy such as by printing the file. In particular, it is desired to insure that the integrity of the printed document remains uncompromised, even if the printed document is scanned, edited and then reprinted.

For example, if a user receives a contract, it is desirable to provide a technique to prevent the contract from being printed out and scanned into a text file, and then changed in a minor or major way without the author being able to detect the change. It is desirable that authentication coding induced in the electronic file survives when rendered to a printed sheet and then back to another text file.

According to an aspect of the present invention, a method of encoding a document to prevent undetected alteration of the document includes identifying symbols to be changed by applying font changes to the identified symbols and generating font change pointers that track changes applied to the identified symbols.

According to an additional aspect of the present invention, a method of decoding an electronic file that represents an authenticated document when rendered to a human discernable form includes obtaining font change pointer values that track font changes applied to text in the electronic file, retrieving font change pointer values stored in an author's database and comparing the obtained font change pointer values to the retrieved font change pointers values stored in the author's database to determine whether each of the pointer values match.

According to an additional aspect of the present invention, a computer program product resides on a computer readable medium. The computer program product includes instruction for encoding a document to prevent undetected alteration of the document. The instructions include instructions to apply font changes to identified symbols in a electronic file representation of the document and generate font change pointers that track font changes applied to the identified symbols.

According to an additional aspect of the present invention, a computer program product resides on a computer readable medium. The product decodes an electronic file that represents an authenticated document when rendered to a human discernable form and comprises instructions for causing a computer to obtain font change pointer values that track font changes applied to text in the electronic file. The program also includes instructions to retrieve font change pointer values store in an author's database and compare the obtained font change pointer values to the retrieved font change pointer values stored in the author's database to determine whether each of the pointer values match.

According to an additional aspect of the present invention, a computer program product residing on a computer readable medium for decoding an authenticated document, includes instructions for causing a computer to apply optical character recognition to a scanned representation of the document to produce an electronic file having recognized text and generated font change pointer values that track font changes that were applied to the text in the document. The program also includes instructions to retrieve font change pointer values stored in an author's database and compare the generated font change pointer values to the retrieved font change pointers values stored in the author's database to determine whether each of the pointer values match.

One or more aspects of the invention may provide one or more of the following advantages.

The invention produces changes in the document that are identifiable by computer. The changes can be detected whether its been printed on a sheet of paper or stored in an electronic format. When the electronic file having the verification changes is rendered on a sheet of paper, the paper can be scanned. One can observe that changes have been made by use of the invention or verify that no changes have been made and thus validate and secure the authenticity of the document.

### BRIEF DESCRIPTION OF THE DRAWINGS

FIG. 1 depicts an arrangement for document authentication.

FIG. 2 is a block diagram of features of a file/document authenticating and verification process.

FIG. 3 is a flow chart of a checksum generation process.

FIG. 4 is a flow chart of a digital signature generation process.

FIG. 5 is a flow chart of a font change base encoding process to a text-based file format.

FIG. 6 is a flow chart of a font change base encoding process applied to an image type file format.

FIG. 7 is a flow chart of a checksum decoding process.

FIG. 8 is a flow chart of a digital signature decoding process.

FIGS. 9A and 9B are flow charts of a font change decoding/verification process applied to a text type file format.

FIGS. 10A and 10B are flowcharts of a font change decoding/verification process applied to an image type file format.

FIG. 11 is a flow chart of a decoding/verification process.

### DESCRIPTION

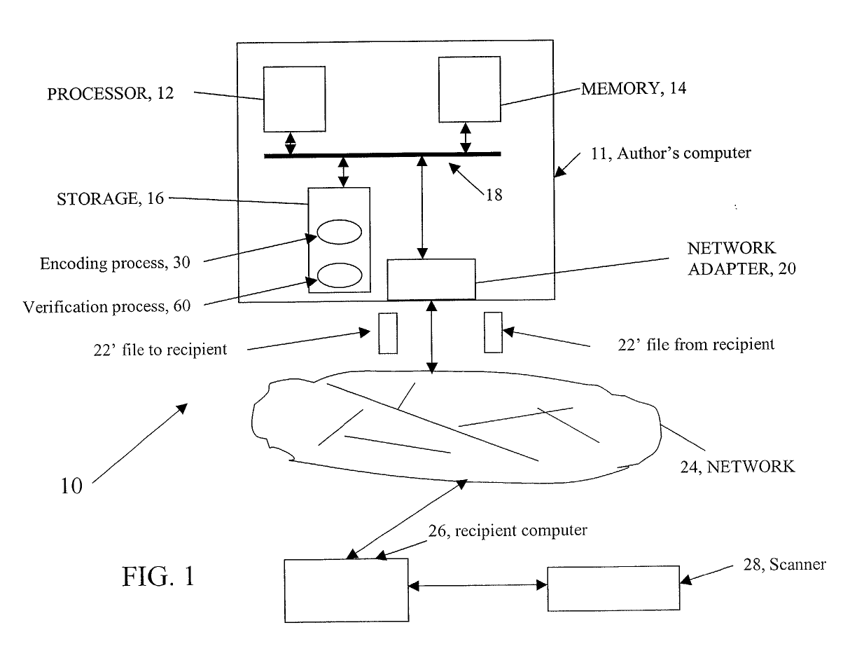

Referring to FIG. 1, arrangement 10 includes a computer 11 that includes a processor 12, memory 14, and storage 16. The processor 12, memory 14 and storage 16 are coupled via a bus 18. Storage 16 also includes a document authentication process 30 that includes an encoding process 32 and a verification process 34. The authentication process 30 is executed in memory 14 through processor 12. The computer 11 here also includes a network adapter 20 or other type of input output device, as well as other devices (not shown) such as a monitor and a keyboard. The computer 11 is in this example is used by an author of a document. The author of the document sends a file 22 to a recipient using any available technique. For example the file can be sent over a network 24 to a recipient computer 26.

Alternatively, the file 22 can be sent to the recipient via a disk such as magnetic or optical or could be printed out as a hard copy document and sent, e.g., mailed or given to the recipient. In this example the file 22 is sent to the recipient over the network 24 and received by the recipient computer 26, which need not be identical to the computer 11.

In this example, the recipient 26 will make unauthorized changes to the document. The recipient can make such unauthorized changes using several techniques. In one example, the recipient makes unauthorized changes in the document in the document's electronic format by using a word processing program to insert the changes. In another example, the recipient can print out the file and scan the printed version with scanner 28 to produce an electronic file format representation of the document. The recipient edits that file using a word processor, or other editor type program in the computer 26. The recipient makes small, minor changes to the document and sends the file back to the author over the network 24, as file 22′. Alternatively, the recipient can make a hard copy (not shown) of the file 22′ and send the modified hard copy back to the author.

The document authentication 30 process that runs on the author's computer encodes 32 the electronic file that represents the document. The document authentication process 30 also later can verify 34 that the file 22′ or hard copy 22a′ received from the recipient is unaltered. If the file 22′ or hard copy 22a′ was altered, the document authentication process 30 through verification process 30 will at least detect that alterations were made to the document.

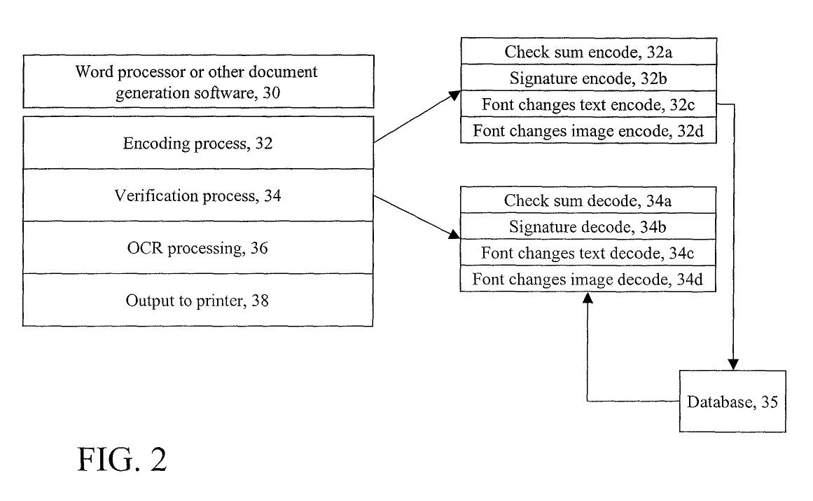

Referring to FIG. 2, document authentication process 30 includes encoding process 32, which renders a document tamper-proof via techniques to be described below, and decoding process 34 that decodes codes or features applied to the document by the encoding process 32. The authentication process 30 uses the decoding process 34 to check for codes generated by the encoding process 32. The codes are stored in a database 35 for a particular document or in the electronic file representation of the document.

The encoding process 32 produces codes to make the document secure and unchangeable without such changes being detected. The encoding process 32 produces the series of codes that are carried with the electronic version of the text file 22. When the electronic version is altered, and sent back to the author, the author can detect that changes were made by examining codes stored in the database against codes in the text file representation of the document or regenerated by a verification process from the text file.

When the document is printed from the text file and thereafter scanned, a print-based verification process (discussed below) generates the series of codes. If any changes occurred to the document, those codes will not match codes stored in the database 35 for the document maintained by the author of the document.

Thus, the series of codes are affected by any change in the document. The codes survive in the document whether the changes are made to the document represented in the original electronic text-based file, 22 or in an electronic file generated by scanning a printed version of the document.

The print-based verification process (discussed below) uses an optical character recognition (OCR) 36 when the document is printed out and needs to be verified. If a document is printed, the auxiliary process would work with any printer/print drivers 38 provided such printer/print drivers use standard, e.g., process 30 supported fonts. If changes were made to the document and the document is reprinted, but not included in the array of fonts available to the driver or printer, then the auxiliary process will not have the same changes in fonts used to mark the document, as will be described below.

The encoding process 32 includes three elements; check sum generation 32a, signature generation 32b, and font change generation 32c. An optional fourth process 32d can be used on image documents. Unlike a watermark process this fourth process 32d alters the bits in an image to produces an array of font changes.

The decoding process 34 also includes three elements; a check sum decoder 34a, signature recovery process 34b, and font change decoding 34c. An optional fourth process 34d decodes the font changes made to image documents if the optional image encoding process was used.

The document authentication process 30 including the encoding process 32 and the decoding process 34 can be integrated into a document generation program 39 such as word processors, e.g., Word Perfect® by Corel, Inc. or Word® by Microsoft, Inc., spreadsheets, and so forth. The document authentication process 30 (encoding process 32 and decoding process 34) can also be used as a standalone process that allows any document to be processed by it.

Codes produced by the code generation process 33 are stored in the generated file 22 and in the database 35. The document can be send electronically or via hardcopy.

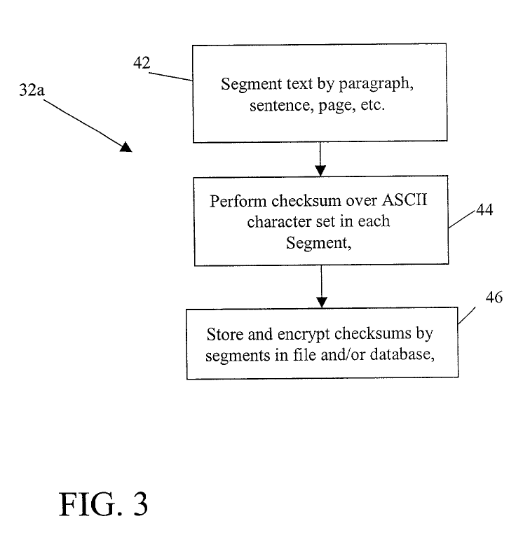

Referring to FIG. 3 a check sum generation process 32a is shown. The check sum generation process 32a breaks up or segments 42 the document into sections, e.g., page, paragraph, sentence, etc. For discussion we will use segmenting on a paragraph basis. The check sum process performs 44 a modulo sum of all of the ASCII characters in each paragraph to generates a single integer that is a checksum. Other calculations could be used and the resulting calculations or checksums could be modified or encrypted during generation to add additional security. The generated checksums are stored 46 in the document database under an item defining locations for each document.

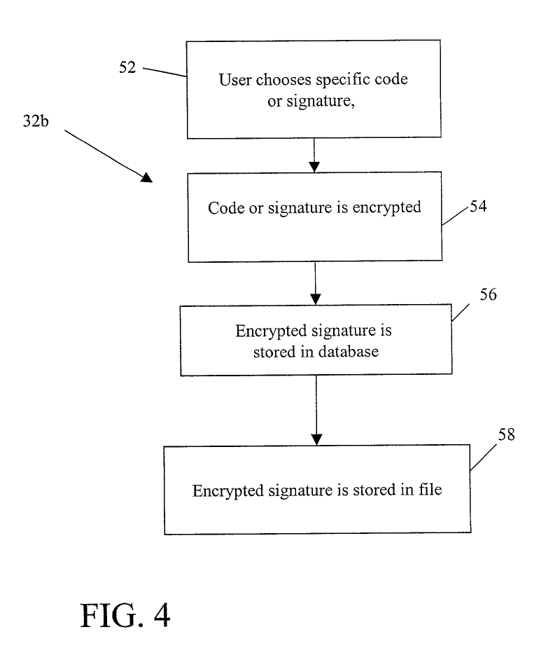

Referring to FIG. 4, a signature generation process 32b allows the user to choose 52 a specific code or signature to identify the document as being originated by the author. The signature is encoded 54 using a 128-bit encryption or any other type of encryption algorithm. That signature is appended 56 in a format that is invisible to a recipient of the document or the file. The signature will not appear in the displayed document. Rather, the signature is embedded in a data structure inside the file. At the same time, the same signature is stored 58 in the database for that particular document.

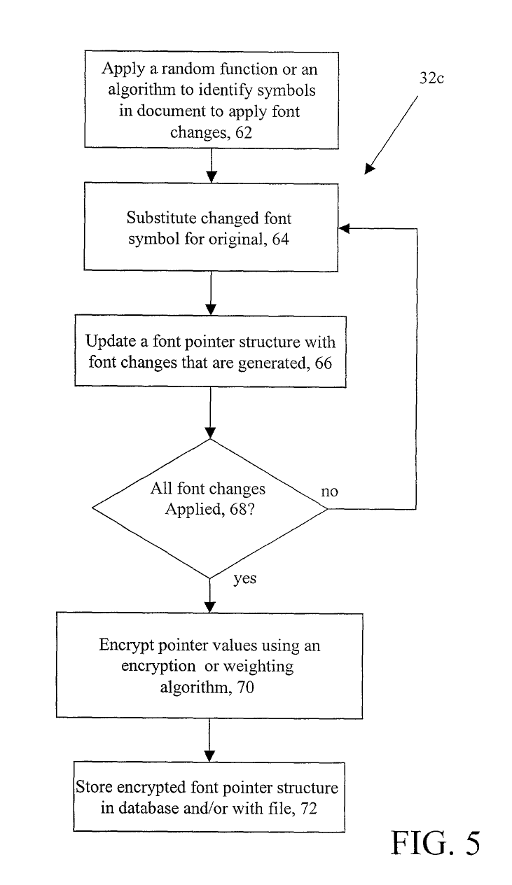

Referring to FIG. 5, the process 32c for generating font changes is shown. The font change generation process 32c identifies 62 which letters to encode and how frequently the process 32c will make font changes to letters. This can be variable depending on both marketing requirements and how secure the user desires to make the document. The more frequently font changes are made, the more secure the document becomes but the more processing that is involved. The changes can either be random or can be done by applying an algorithm. In other words, the changes can be spaced by some random number of letters or they can be spaced by every n^{th} letter or letter spacing can be generated by a polynomial, etc. The process 32c substitutes 64 the changed font letters for the original letters in the locations identified in the electronic file. The file format, as a result, automatically generates font pointers, which mark those changes. Font pointers are essentially counters.

One embodiment of a pointer is a table of integer numbers that hold a (numeric) offset to a font change measured from the beginning of the document. The measure unit is bytes.

### EXAMPLE

Pointer 1=0x00003df6=15862

In this example Pointer 1 means that the first font change occurred at a document offset of 15862 bytes, where 0 bytes is the beginning of the document.

The values of the font pointer are stored and/or updated 66. Font change pointers are automatically generated and track the font changes. After the document has been completely encoded 68 (or at regular stages, e.g., every pass, and so for) the font change pointer values are encrypted 70. The font change pointer can be encrypted in several ways. One is standard encryption, another way is pointer weighting which can be dependent on the type of letter being changed and how many times a particular letter is changed, or other possible ways of weighting.

The encrypted values for the pointer changes are stored 72 in the database 35. In one embodiment, the process 30 stores changes in pointer values. In another embodiment, the process stores the actual changes in an encrypted manner. The font change pointers are stored in the database and in the document in encrypted format under a location pertaining to that particular document for use in later verification.

Font changes can be of various types. For example one type of font change changes, e.g., a Times New Roman character to a similar but not the same font type, e.g., Arial or changes the font size slightly but keeps the same font. Fonts can be changed in any desired manner. Thus, in one instance when changing font styles the changes are discernable to a human whereas in other techniques the changes are imperceptible. For example, Courier New and Times New Roman fonts are quite different and substitutions would be quite noticeable. The process 32c can use groups of interrelated fonts that are similar in appearance such that the changes are not noticeable. Thus, at the option of the user the user can produce documents that have the appearance of being a secure document or can hide the fact that the document has been secured.

Other changes can be applied. For example another change that can be applied to the document is to change the font centroid. Font centroid changes are subtle changes that displace the location of a symbol from its original expected location within a small region that is defined for the letter. Every letter has a center point in an imaginary box and changing the font centroid modulates the location of the letter within the box about that center point.

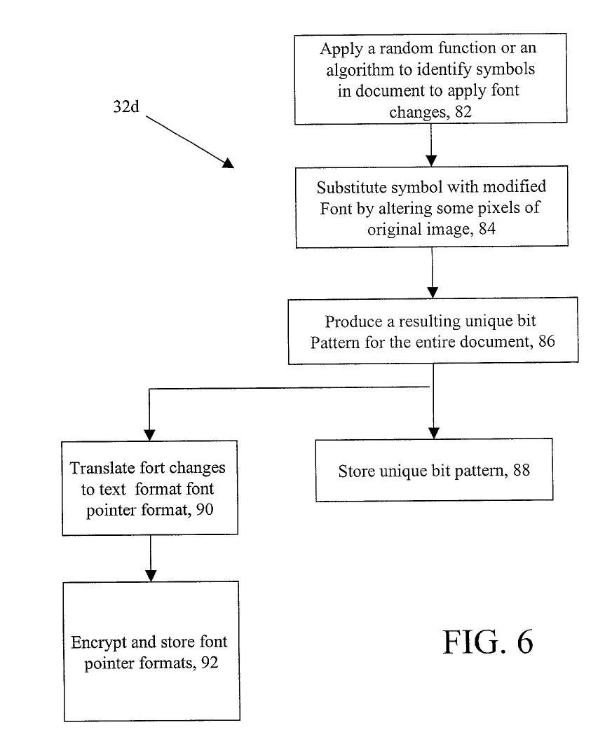

Referring to FIG. 6, bit map image encoding 32d process identifies 82 letters to be changed to a different font, either randomly or using some type of algorithm. In the bit map image an encoding process 32d substitutes 84 the changed fonts of selected letters for the original fonts by altering some of the pixels of the original letters. In this embodiment, the image encoding process 32d operates on a PDF format or an image type format to produce 86 a resulting unique bit pattern for the entire document. The resulting bit pattern is stored 88 in the PDF or in other image type file. However, for verification purposes, at the same time those changes are stored, the process translates 90 those changes into changes as represented by font change pointers. The process 32d translates these changes because when character recognition of a document is run for verification that document will be stored in a text style format. The way that the text-style format signifies font changes is with font location change pointers. In other words, the image encoding process 32d essentially simulates what would have happened if the same changes had been done to a text format file, as in FIG. 5. The image encoding process protects those font changes as in the previous process by encryption and/or by weighting and those pointer values are stored 102 under a data location in the database.

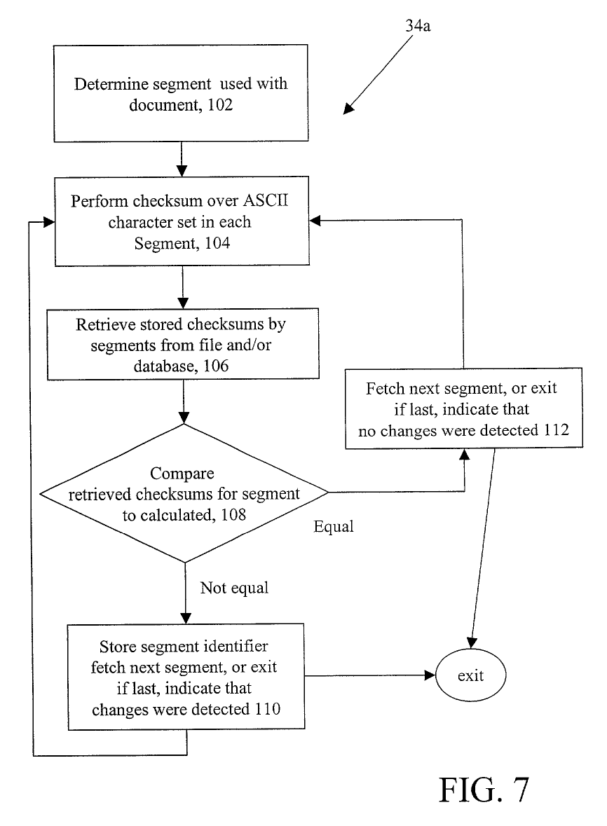

Referring now to FIG. 7, checksum decoding process 34a determines 102 the segment type used to encode the document. The checksum decoding process 34a performs 104 a checksum over the ASCII characters in each of the determine segments. The process 34a retrieves 106 stored checksums by segment type from the file 22, 22′ and/or the database 35. The checksum decoding process 34a compares 108 checksums retrieved from the file 22, 22′ and/or database 35 to checksums calculated over the segment. If the checksums are equal, the process 34a will fetch the next segment or exit if it is at the last segment. However, if the process 34a determines that the checksums were not equal, then the process will store 110 the segment identification and fetch the next segment or exit if at the last segment. Upon exit the process 34a will determine if it detected changes in any of the segments and will communicate changes or no changes to the user.

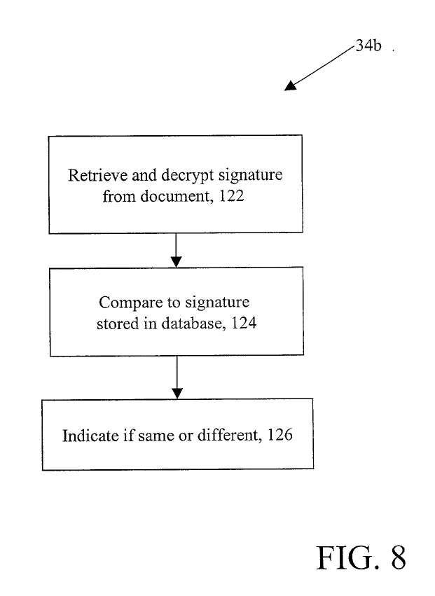

Referring to FIG. 8, a signature verification process 34b includes retrieving and decrypting signatures from the document 142. The retrieved signature from the document is compared 144 to the signature stored in the database. The process 34b will indicate if the signatures are the same or different.

A signature essentially identifies the owner of the document. Once the signature is decrypted, it can be compared to what is stored in the database for that document. On the other hand, a checksum is checked on a sector basis, e.g., paragraph by paragraph. The checksums are compared to what is stored in the document database to detect if there were any changes.

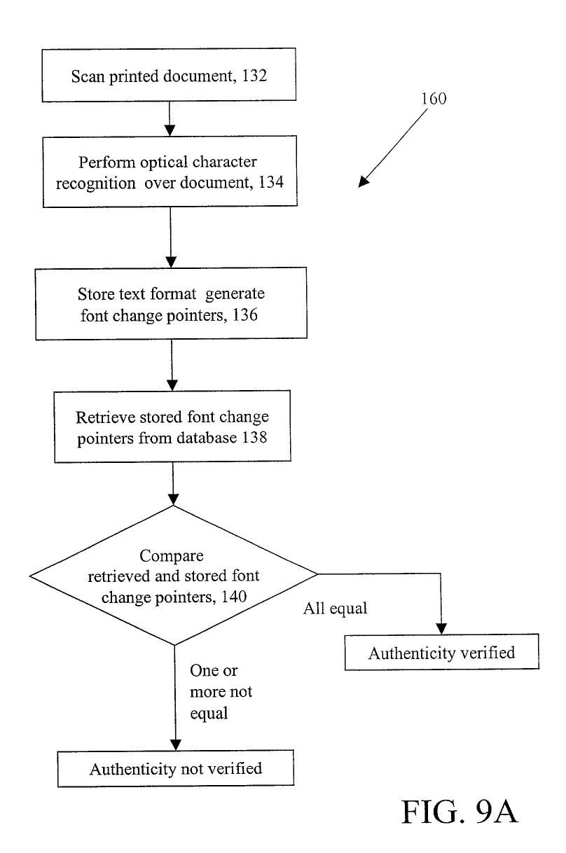

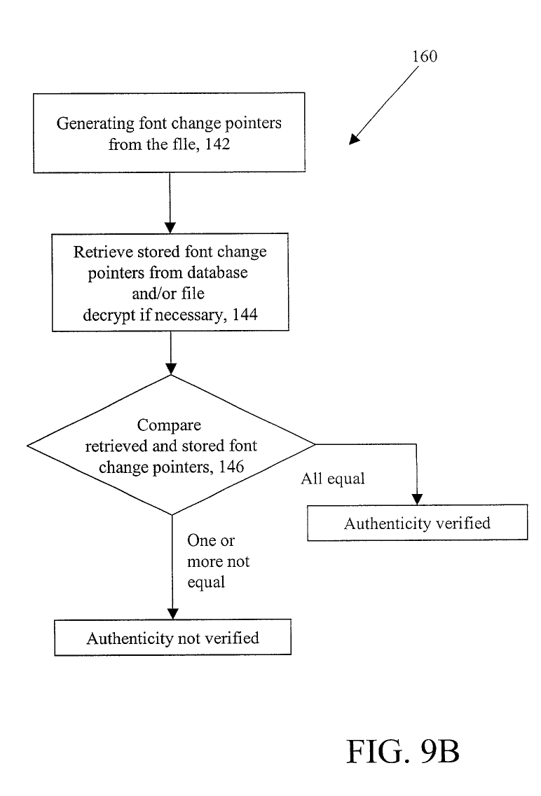

Referring to FIG. 9A one embodiment 34c′ of text-based verification 34c is shown for a printed document. Verification 34c′ for a printer document includes scanning 132 of the document and performing 134 optical character recognition to capture and store 136 the original text and all font changes that were made to the document. The text file is generated from the output of the character recognition algorithm and the resulting format will generate font change pointers. The font change pointers will be retrieved 138 in the document database for the original document and compared 140 to the values generated by OCR. If the comparison yields the same font pointer values then the authenticity is verified; otherwise, the authenticity is not verified.

Referring to FIG. 9B an embodiment 34c″ of text-based verification 34c is shown for an electronic file representing a document. Verification 34c″ includes generating font changes 142 from the electronic file 22′. The font change pointers that were previously generated by the author are retrieved 144 from the database 35 or the file 22′ for the original document, and decrypted if necessary. The retrieved and generated font change pointers are compared 146 to the values generated from the file. If the comparison yields the same font pointer values then the authenticity is verified; otherwise, the authenticity is not verified.

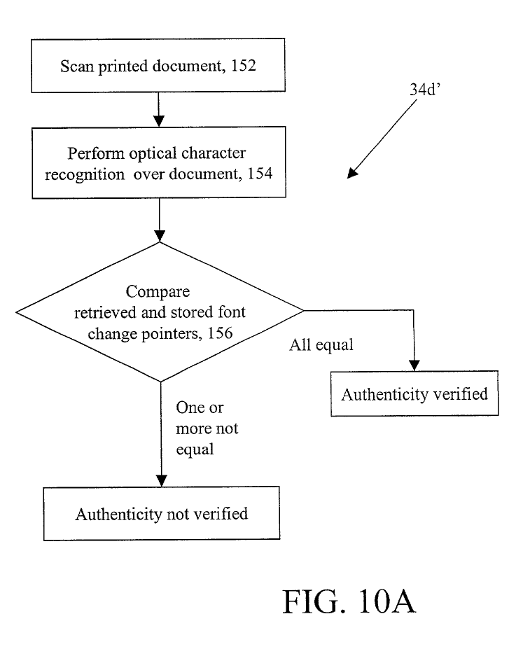

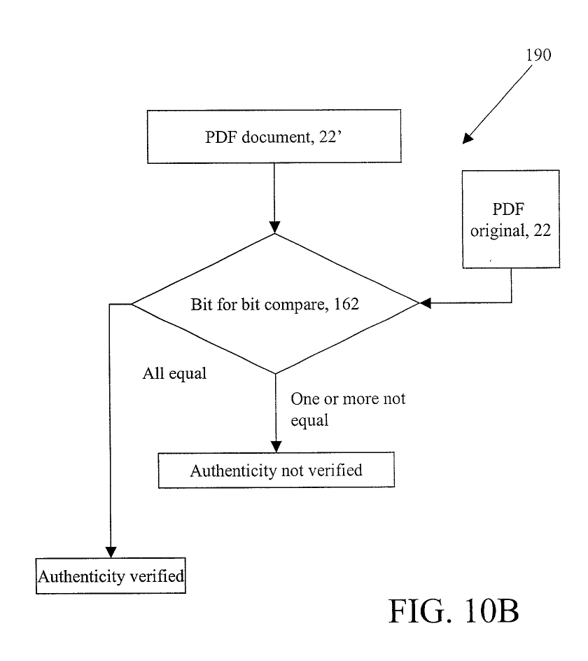

Referring to FIG. 10, verification 34d′ of a printed document, which originated as a PDF format or other image type format is shown. The printed document is scanned 152 and operated on by an optical character recognition process 154 that generates a text format file with font pointers. Those font pointers are compared 156 to the font pointers stored in the database for that particular document.

Referring to FIG. 10B, verification process 34d″ for an image format document, e.g., PDF that is represented as an electronic file, and not printed is shown. To verify such a document represented in the received electronic image file 22′ includes performing 162 a bit by bit comparison of that document 22′ to the original electronic file 22 to detect bit changes. Again, if the comparison is bit for bit correct, then the document is authenticated otherwise the authentication fails.

Optical character recognition is used to recognize font changes from scanned printed documents. OCR allows a user to scan a document and recognize characters in the document. Optical character recognition produces a text file from scanning the document that is in e.g., ASCII format. It also produces a set of fonts, from which font change pointers are generated. OCR is capable of recognizing fonts while scanning images. Starting at the beginning of the document the process 30 produces a table of font changes (Pointers) that can be compared to a stored font table.

In a hard copy format the optical character recognition process identifies the font changes without having to go through the cumbersome process of actually scanning an image and detecting changes bit by bit as is done in detecting a classical watermark. Thus, one of the differences between the watermark approach and this approach is that this approach can work on text format documents. With an image file, e.g., a PDF file where the document is in an image format, the process makes the same font changes except upon the image.

In a preferred application, authentication of a document is accomplished by generating and maintaining font changes, and/or applying sector check sums to selected sectors. The sector checksums allow verification of sections of the document. All of the font change pointers can be stored in sectors as opposed to saving them all in one location. In this manner the process permits identification of exactly which sector(s) were changed and allows possible recovery of the original document.

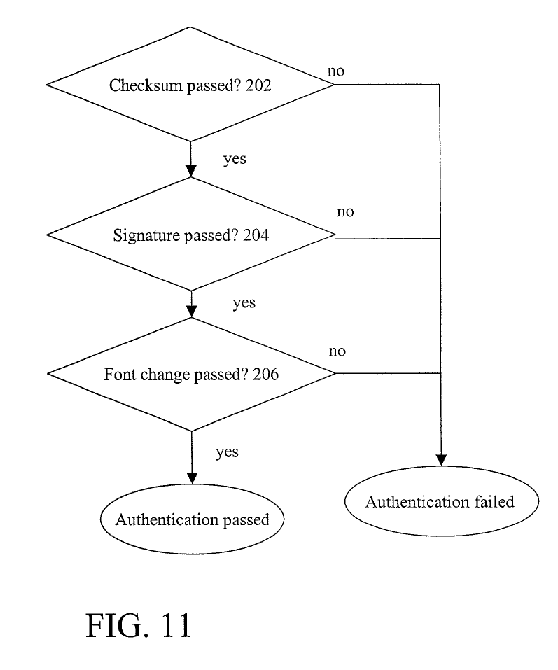

Referring to FIG. 11, one of the preferred ways of implementing the document authentication process 30 uses sectored checksums process 32a and decoding 34a in combination with font changes 32c (text) or 32d (image) and decoding 34c (text) or 34d (image), and optionally the signature process 32b and decoding 34b. This combination allows the checksums to capture changes to a particular letter. However, checksums could be vulnerable because they cannot detect if all of the letters have been changed in order to regenerate the same check sum. A particular document can have a paragraph that is completely changed as long as the checksum comes out the same. However, used in tandem with the font authentication technology, the font authentication technology does not allow more than perhaps a single letter or two to be changed. Thus, when used in tandem with the checksum, the checksum will then catch a single letter being changed, which the font change technology does not. On the other hand the font change process will not allow a checksum to be subverted so an entire paragraph is changed just to regenerate the same sector checkmark. The signature provides an added degree of security.

Additionally, to improve the security of the checksum process, a nonce (secret) or other technique can be applied to generate the checksum so that a recipient cannot simply generate the checksum. Of course, upon verification of the checksum, by the author or holder of the nonce, the nonce or other technique is applied while decoding of the checksum. In addition, use of the digital signature insures that any electronic file received from a recipient originated with the author and was not recreated by the recipient.

Other embodiments are within the scope of the appended claims.

What is claimed is:

1. A method of encoding a document to prevent undetected alteration of the document comprises:
identifying symbols to be changed by applying font changes to the identified symbols; and
generating font change pointers that track changes applied to the identified symbols.

2. The method of claim 1 wherein identifying is variable depending on how secure a user desires to make the document.

3. The method of claim 1 wherein the identified symbols to apply changes to are randomly selected.

4. The method of claim 1 wherein the identified symbols to apply changes to are selected by applying an algorithm to select which of the characters in the document are changed.

5. The method of claim 1 wherein applying font changes comprises:
substituting changed font symbols for the original symbols in locations identified in the electronic file.

6. The method of claim 1 wherein font pointers are encrypted and stored in a database that is maintained by the user or in the electronic file.

7. The method of claim 1 wherein the font change pointers that are automatically generated track the font changes.

8. The method of claim 1 wherein the document is encrypted by pointer weighting that depends on the type of letter being changed and how many times a particular letter is changed.

9. The method of claim 1 wherein applying font changes comprises:
changing a font of a character slightly to the same character in the same or to a similar font type.

10. The method of claim 1 wherein applying font changes comprises:
changing font styles such that the changes are discernable to a human.

11. The method of claim 1 wherein applying font changes comprises:
changing font styles such that the changes are imperceptible to a human.

12. The method of claim 1 wherein applying font changes comprises:
changing a font centroid to displace the location of a symbol from its original, expected location within a small region that is defined for the symbol.

13. A method of decoding an electronic file that represents an authenticated document when rendered to a human discernable form, the method comprises:
obtaining font change pointer values that track font changes applied to text in the electronic file;
retrieving font change pointers values store in an author's database; and
comparing the obtained font change pointer values to the retrieved font change pointers values stored in the author's database to determine whether each of the pointer values match.

14. The method of claim 13 wherein obtaining font change pointers comprises:
generating font change pointer values from the file.

15. The method of claim 13 wherein obtaining font change pointers comprises:
retrieving encrypted font change pointer values from the file; and
decoding the retrieved font change pointer values.

16. A method of decoding an authenticated document, the method comprises:
scanning the document;
applying optical character recognition to produce an electronic file having recognized text and generated font change pointer values that track font changes that were applied to the text in the document;
retrieving font change pointers values stored in an author's database; and
comparing the generated font change pointer values to the retrieved font change pointers values stored in the author's database to determine whether each of the pointer values match.

17. A computer program product residing on a computer readable medium for encoding a document to prevent undetected alteration of the document comprises instructions for causing a computer to:
apply font changes to identified symbols in a electronic file representation of the document; and
generate font change pointers that track font changes applied to the identified symbols.

18. The computer program product of claim 17 wherein instructions to apply further comprise instructions to:
identify symbols using an algorithm that randomly selects symbols to apply font changes.

19. The computer program product of claim 17 wherein instructions to apply font changes further comprise instructions to:
substitute modified font symbols for the original symbols in locations identified in the electronic file.

20. The computer program product of claim 17 wherein instructions to apply further comprise instructions to:
encrypt font pointers and store the encrypted font change pointers in a database that is maintained by the user or in the electronic file.

21. The computer program product of claim 17 wherein the font change pointers that are automatically generated track the font changes.

22. The computer program product of claim 17 wherein instructions to apply further comprise instructions to:
change a font of a character slightly to the same character in the same or to a similar font type.

23. The computer program product of claim 17 wherein instructions to apply further comprise instructions to:
change font styles such that the changes are imperceptible to a human.

24. The computer program product of claim 17 wherein instructions to apply further comprise instructions to:
change a font centroid to displace the location of a symbol from its original, expected location within a small region that is defined for the symbol.

25. A computer program product residing on a computer readable medium for verifying authenticity of an electronic file that represents a document when rendered to a human discernable form, comprises instructions for causing a computer to:
obtain font change pointer values that track font changes applied to text in the electronic file;
retrieve font change pointer values stored in an author's database; and
compare the obtained font change pointer values to the retrieved font change pointers values stored in the author's database to determine whether each of the pointer values match.

26. The computer program product of claim 25 wherein instructions to obtain font change pointers comprises instructions to:
retrieve encrypted font change pointer values from the file; and
decode the retrieved font change pointer values.

27. A computer program product residing on a computer readable medium for decoding an authenticated document, comprises instructions for causing a computer to:
apply optical character recognition to a scanned representation of the document to produce generated font change pointer values that track font changes that were applied to the text in the document;
retrieve font change pointer values stored in an author's database; and
compare the generated font change pointer values to the retrieved font change pointers values stored in the author's database to determine whether each of the pointer values match.

28. The computer program product of claim 27 wherein the electronic file further includes recognized text.
